(19) United States
(12) Patent Application Publication
(10) Pub. No.: US 2010/0256533 A1
(43) Pub. Date: Oct. 7, 2010

(54) Controller for a Massage Device and its Control Method

(76) Inventor: Wen-Hsu Hsieh, Changhua (CN)

Correspondence Address: Dr. BANGER SHIA;Patent Office of Bang Shia, 102 Lindencrest Ct., Sugar Land, TX, 77479-5201, US

(21) Appl. No.: 12/280,349

(22) PCT Filed: Apr. 28, 2007
(86) PCT No.: PCT/CN07/01440

§ 371 Date: Aug. 21, 2008

(30) Foreign Application Priority Data
Apr. 4, 2007 (CN) 200710090711.2

(51) Int. Cl. A61H 7/00

(52) U.S. Cl. 601/1

(57) ABSTRACT

A brand new controller for a massage device and its control method which is electrically connected to and fixed on the massage device, and comprises a body, at least one triggering path and a plurality of sensors. The triggering path is disposed on the body, and the sensors are located correspondingly to an extending direction of the triggering path and are disposed on the body. The triggering path is provided with a plurality of contact areas that are located correspondingly to the sensors. When the user continuously triggers at least more than two sensors along a predetermined path surface of the triggering path, a control member will make the massage device produce a control action which is different from the function of the sensors, so as to improve the control convenience, reduce the size of a controller panel and the number of the sensors.

### BACKGROUND OF THE INVENTION

1. Field of the Invention

The present invention relates to a controller for adjusting various effects of a massage device and its control method, and more particularly to a controller for a massage device and its control method which can improve the control convenience, reduce the size of a controller panel and the number of sensors.

2. Description of the Prior Art

In recent several decades, the market of massage devices has been developed rapidly since more and more people attach importance to health, and many people of ordinary families often use the massage device to get through meridian and to relieve pain. Therefore, an electric massage device has gradually become an important equipment for the ordinary families.

An automatic massage device comprises multi-kinds of forms, the earlier developed massage device often has simple functions many of which are unadjustable. However, the current massage device has diversified and adjustable functions, such as a massage device disclosed in Japanese patent publication number 10-179667 as shown in FIG. 1, which comprises a controller 10 fixed thereon. The controller 10 is provided with an operating surface 11 having a plurality of keys 12 and tumble handles 13. The keys 12 are used to change the diversified functions, and the tumble handles 13 are used to adjust strong and weak function, and ascending and descending function. However, such a massage device still has the following disadvantages:

Firstly, in order to achieve the diversified and adjustable effects of the current automatic massage device, the controller 10 must be provided with the larger operating surface 11 which still have to be provided with the plurality of keys 12 and the plurality sets of tumble handles 13 for operating with many functions, and these components will occupy space, so that the size of the controller 10 cannot be reduced.

Secondly, since the operating surface 11 must be provided with the plurality of keys 12 and the plurality sets of tumble handles 13 for operating with many functions, each key 12 and tumble handle 13 must be provided with a sensor and a circuit, such that the formed circuit and controlling assembly will become complex, as a result, the cost is relatively high, the number of the components is increased and the structure is complex.

At this time, in order to obtain a smaller controller, the current technology is to use the mode of restricting group function, such as, setting bruteforce mode and soft mode keys to reduce the trouble of choosing different functions. However, such an improving technology means the abandonment of freely adjusting, and cannot adjust the intensity according to different user's requirements. As a result, the competitive ability of the products is largely reduced and many problems will be caused.

It is apparent from the above-mentioned descriptions that the controller for the conventional massage device will not be added with keys unless it is necessary, but multi-function is the key of market competition, so such a contradictive problem has long become an important point that the manufacturers are improving.

The present invention has arisen to mitigate and/or obviate the afore-described disadvantages.

### SUMMARY OF THE INVENTION

The primary objective of the present invention is to provide a controller for a massage device and its control method which can reduce the size of a controller panel, simplify the components and reduce the cost.

To achieve the objective of the present invention, at least one triggering path is disposed on a body, and a plurality of sensors are located correspondingly to an extending direction of the triggering path and is disposed on the body. The triggering path is provided with a plurality of orderly connected contact areas that are located correspondingly to the sensors. When the user continuously triggers at least more than two sensors along a predetermined path surface of the triggering path, a control member will make the massage device produce a control action which is different from the function of the sensors. By using such a controller, the present invention can increase the number of the control functions by using less sensors cooperating with the triggering path, and can reduce the size of the controller panel and the number (cost) of the sensors.

The control method of the present invention utilizes the controller which is provided with at least one triggering path and one control member, and the plurality of sensors are located correspondingly to the extending direction of the triggering path. When the user continuously triggers at least more than two sensors along a predetermined direction of the predetermined path surface of the triggering path, the control member will make the massage device produce a function control which is different from the function control produced when triggering the single sensor. By using such a control method, the present invention can increase the number of the control functions by using less sensors cooperating with the triggering path, and can reduce the size of the controller panel and the number (cost) of the sensors.

The second objective of the present invention is to provide a controller for a massage device and its control method which can improve the control convenience.

To achieve the objective of the present invention, the plurality of orderly connected contact areas are disposed on the triggering path and are located correspondingly to the sensors. When the user continuously triggers at least more than two, or three, or four adjacent sensors by his/her finger along the predetermined path surface of the triggering path, the control member will produce the control action that is different from the function of the single sensor. By the triggering path and the sliding of the user's finger, the user can easily trigger different functions, thus improving the control convenience.

With the control method of the present invention, when the user continuously triggers at least more than two sensors by his/her finger along the predetermined direction of the predetermined path surface of the triggering path, the control member will make the massage device produce the function control which is different from the function control produced when triggering the single sensor. By such a control method, the user can easily trigger different functions, thus improving the control convenience.

It is to be noted that the control member can cooperate with a LED light source assembly and a sound effect assembly to inform the user, such that the user can also know the adjustment state of different functions precisely. In addition, the sensor can be an ordinary capacitive sensor, a proximity sensor or a pressure sensor.

Moreover, the triggering path of the present invention is a smooth surface for the user's finger to slide thereon, a guiding structure can be protruded out of a periphery of the triggering path, and the path surface of the triggering path can be designed to be flat or arc-shaped. The arc-shaped path surface will increase the smooth feeling in accord with human engineering.

To summarize, the controller of the present invention comprises at least one triggering path that is disposed on the body, and the plurality of sensors are located correspondingly to the extending direction of the sensors and are disposed on the body. The plurality of orderly connected contact areas are disposed on the triggering path and are located correspondingly to the sensors. When the user continuously triggers at least more than two sensors by his/her finger along the predetermined path surface of the triggering path, the control member will make the massage device produce the control action that is different from the function of the single sensor. Thereby, the present invention can increase the number of the control functions by using less sensors cooperating with the triggering path, and can reduce the size of the controller panel and the number (cost) of the sensors. In addition, the contact areas which disposed on the triggering path are located correspondingly to the sensors, such that when the user continuously triggers at least more than two, or three, or four adjacent sensors by his/her finger along the predetermined path surface of the triggering path, the control member will produce the control action that is different from the function of the single sensor. By the triggering path and the sliding of the user's finger, the user can easily trigger different functions, thus improving the control convenience.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing a conventional massage device;

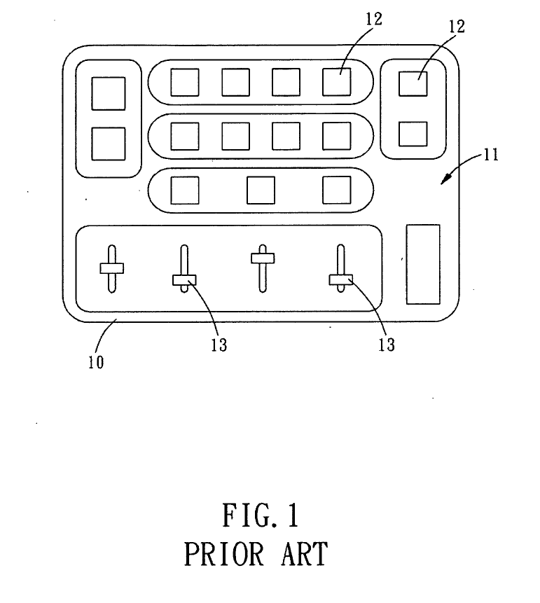

FIG. 2 is an illustrative view showing a controller for a massage device in accordance with the present invention;

FIG. 3 is a perspective view of the controller for a massage device in accordance with a first embodiment of the present invention;

FIG. 4 is a cross sectional view of the controller for a massage device in accordance with the present invention;

FIG. 5 is an illustrative view showing an operation of the controller for a massage device in accordance with the present invention;

FIG. 6 is an illustrative view showing the operation of the controller for a massage device in accordance with the present invention;

FIG. 7 is an illustrative view showing a control method of the controller for a massage device in accordance with the present invention;

FIG. 8 is an illustrative view showing the control method of the controller for a massage device in accordance with the present invention;

FIG. 9 is a perspective view of the controller for a massage device in accordance with a second embodiment of the present invention; and

FIG. 10 is a perspective view of the controller for a massage device in accordance with a third embodiment of the present invention.

### DETAILED DESCRIPTION OF THE PREFERRED EMBODIMENTS

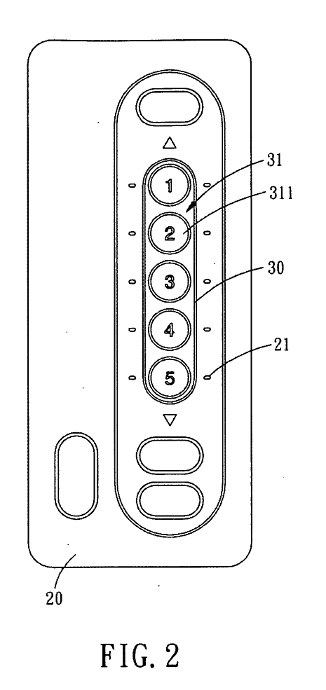

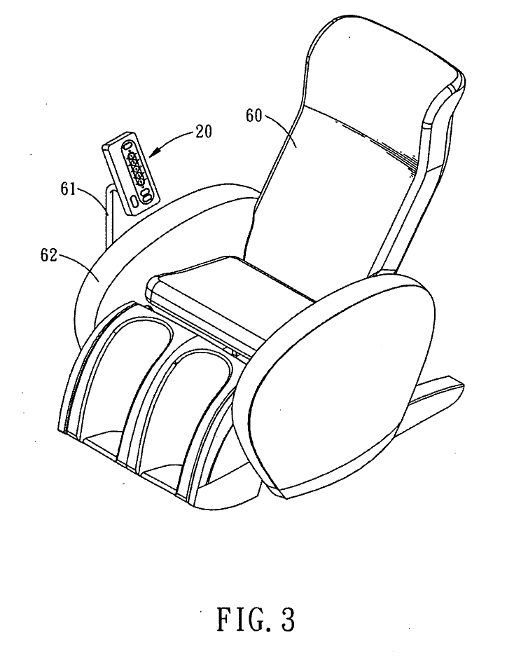

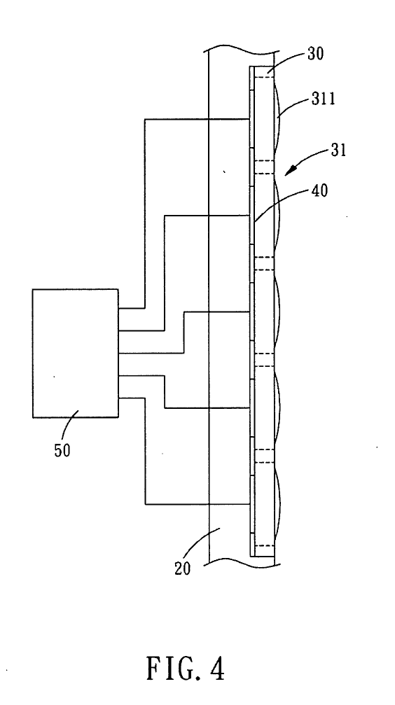

Referring to FIGS. 2-4, a controller for a massage device in accordance with the present invention comprises a body 20, a triggering path 30, a plurality of sensors 40 and a control member 50. The body 20 cooperates with a supporting rack 61 to fix at one side of one armrest 62 of a massage chair 60.

The body 20 is a box-shaped member and is provided with a plurality of LED lamps 21.

The triggering path 30 is disposed on the body 20 and is provided with a smoothly extended straight line path surface 31 for the user's finger to slide smoothly. The straight line path surface 31 of the triggering path 30 is divided into a plurality of adjacent and orderly connected contact areas 311, each contact area 311 is provided with a predetermined functional symbol, and is located side by side and correspondingly to one of the LED lamps 21 of the body 20.

The sensors 40 are disposed on the body 20 and are located correspondingly to the contact areas 311 of the triggering path 30. When foreign objects touch the contact areas 311, the contact areas 311 will make the sensors 40 produce signals. The respective sensors 40 can be an ordinary capacitive sensor, a proximity sensor or a pressure sensor.

The control member 50 is disposed in the body 20 and is electrically connected to the sensors 40 and the LED lamps 21 of the body 20. When the single sensor 40 produces signals, the control member 50 will receive the signals and produce a predetermined function control which controls more than one of the functionally quantitative adjustments of massage intensity, massage speed and massage time.

A control method of the present invention is described as follows: when the user continuously triggers at least more than two of the adjacent contact areas 311 along a predetermined direction of the straight line path surface 31 of the triggering path 30 by his/her finger to continuously trigger at least more than two of the adjacent sensors 40 in a predetermined direction, the control member 50 will make the massage chair 60 produce a function control which is different from the function control produced when triggering the single sensor 40. For example, the control member 50 will produce a predetermined function control or position control of the massage device, and the position control of the massage device is the relative position or angle of the quantity adjusted massage device and the massaged person.

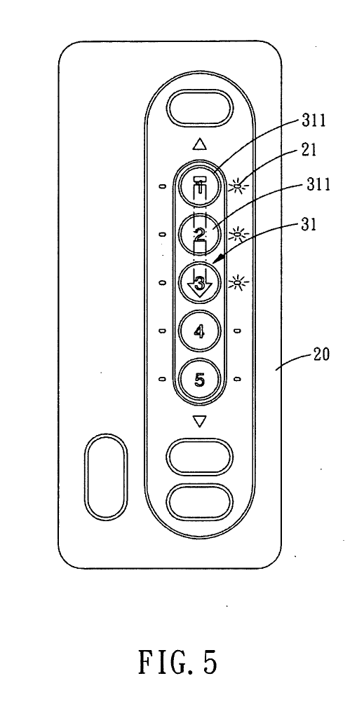

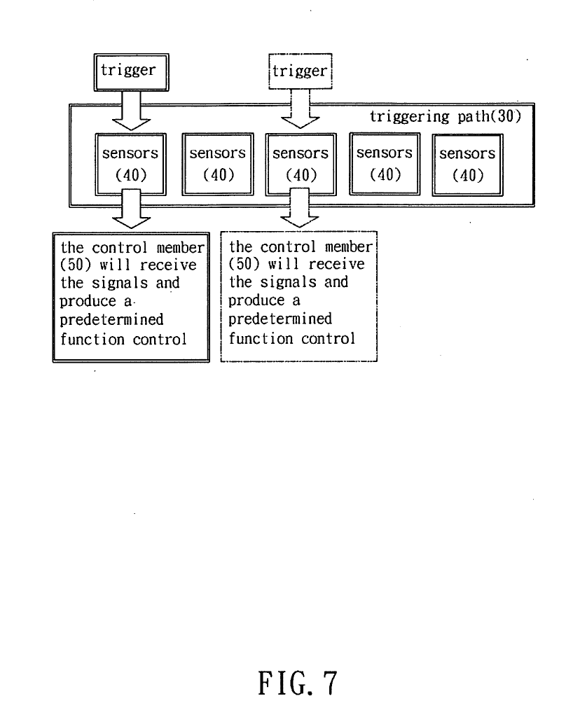

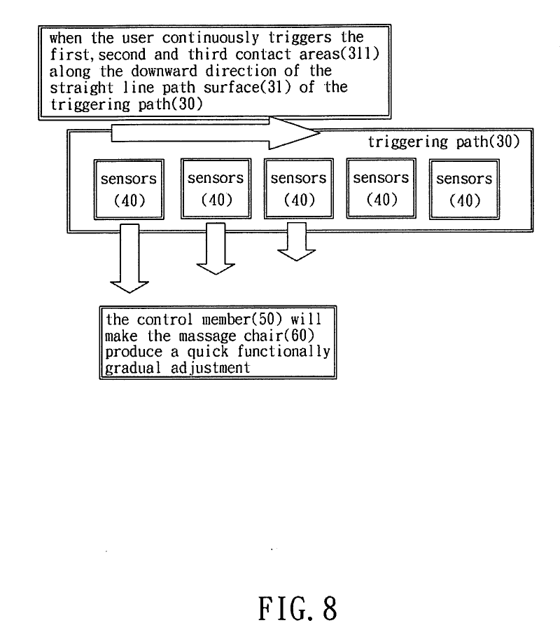

Referring to FIGS. 5-8, when the user continuously triggers the first, second and third contact areas 311 along the downward direction of the straight line path surface 31 of the triggering path 30 by his/her finger to continuously trigger three adjacent sensors 40 in the downward direction, the three LED lamps 21 of the body 20 will continuously glitter towards the downward direction, and the control member 50 will make the massage chair 60 produce a quick functionally gradual adjustment (continuously trigger three sensors 40), such as, gradually reducing the massage intensity, gradually lowering the massage chair 60, and gradually adjusting the position and angle of the massage device.

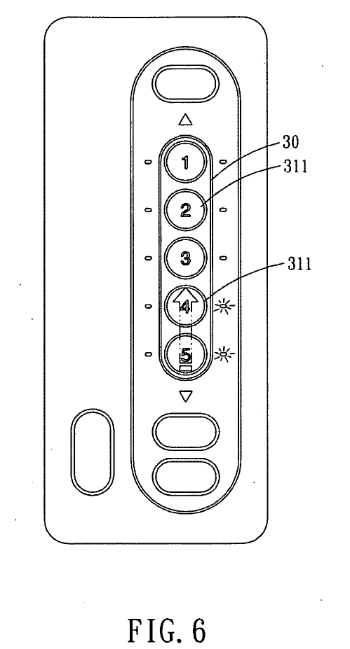

Referring to FIG. 6, when the user continuously triggers the fifth and fourth contact areas 311 along the upward direction of the straight line path surface 31 of the triggering path 30 by his/her finger to continuously trigger two sensors 40 in the upward direction, the two LED lamps 21 of the body 20 will continuously glitter towards the upward direction, and the control member 50 will make the massage chair 60 produce a slow functionally gradual adjustment (only continuously trigger two sensors 40), such as, gradually strengthening the massage intensity, gradually adjusting the sitting gesture of the massage chair 60, and gradually adjusting the position and angle of the massage device.

It is apparent from the above-mentioned descriptions that the controller for a massage device and its control method of the present invention can produce more than five functional adjustments within the restriction of the five contact areas 311 of the triggering path 30, can increase the number of the control functions by using less sensors 40 cooperating with the triggering path 30, and can reduce the size of a controller panel and the number (cost) of the sensors 40.

In addition, it is to be noted that the LED lamps of the body 20 of the present invention can continuously glitter towards a predetermined direction by cooperating with the contact areas 311, so as to adequately provide the basis for judging and confirming the operation. Moreover, the controller is connected to a sound effect assembly that is also electrically connected to the control member 50. The assistant confirming mode can also be informed by the sound effect, or the LED lamps 21 and the sound effect.

The sensor 40 of the present invention can be an ordinary capacitive sensor, and the control method of the present invention is applicable to both proximity sensors and general used induction equipments, so the shape change of the sensors 40 is still within the scope of the present invention.

The contact areas 311 of the present invention can be continuously triggered by sliding the user's finger, or by quickly and continuously clicking within a certain period of time, such as, the user clicks the adjacent contact areas 311 less than 0.5 seconds is viewed as continuously clicking, and continuously clicking the adjacent areas 311 towards the predetermined direction within a predetermined time difference can also achieve the control effect of the present invention.

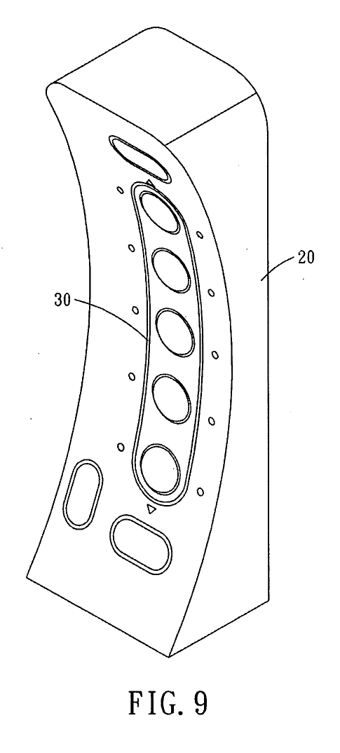

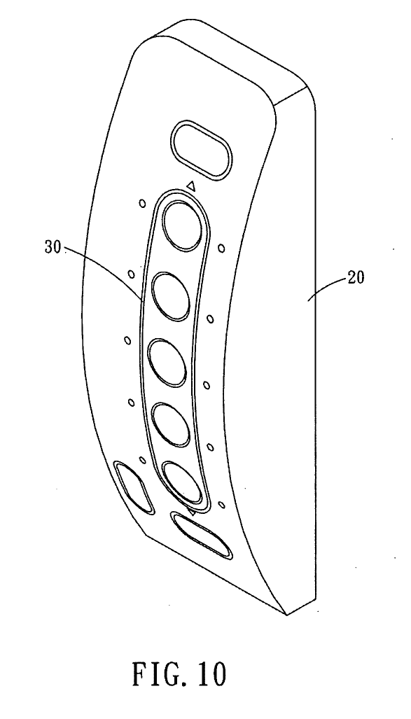

Referring to FIGS. 9 and 10, it is to be noted that the triggering path 30 of the body 20 can achieve the effect of the present invention simply by providing the smooth surface for the user's finger to slide thereon, and the triggering path 30 can also produce the same effect whether it is flat, bended, concave arc-shaped, or convex arc-shaped. Especially for the concave arc-shaped triggering path 30 which produces the concave arc-shaped path surface as shown in FIG. 9, or the convex arc-shaped triggering path 30 which produces the convex arc-shaped path surface as shown in FIG. 10, which will not only increase the smooth feeling in accord with human engineering, but also can improve the fashion style of the whole appearance.

Finally, the triggering path 30 of the present invention can be designed to be flushed with the body 20 (plane or arc-shaped surface), and a guiding structure can also be protruded out of a periphery of the triggering path 30 to improve the effect of guiding the user's finger.

While we have shown and described various embodiments in accordance with the present invention, it should be clear to those skilled in the art that further embodiments may be made without departing from the scope of the present invention.

What is claimed is:

1. A controller for a massage device, comprising: a body fixed on the massage device, at least one triggering path, a plurality of sensors and at least one control member, characterized in that:
the triggering path is disposed on the body and is provided with a plurality of adjacent and orderly connected contact areas;
the sensors are disposed on the body and are located correspondingly to the contact areas of the triggering path, when foreign objects touch the contact areas of the triggering path, the contact areas will make the sensors produce signals;
the control member is electrically connected to the sensors, when the single sensor produces signals, the control member will receive the signals and produce a predetermined function control, when a user continuously triggers at least more than two of the adjacent contact areas along a predetermined direction of the triggering path, the control member will make the massage device produce another predetermined function control;
a plurality of LED lamps are disposed on the body, each contact area is located side by side and correspondingly to one of the LED lamps of the body, and the control member is electrically connected to the LED lamps.

2. The controller for a massage device as claimed in claim 1, wherein the sensors are selected from the group consisting of an ordinary capacitive sensor, a proximity sensor and a pressure sensor.

3. The controller for a massage device as claimed in claim 1, wherein the contact areas of the triggering path form a path surface for the user's finger to trigger, and the path surface is selected from the group consisting of a flat path surface, a bended path surface, a concave arc-shaped path surface and a convex arc-shaped path surface.

4. The controller for a massage device as claimed in claim 3, wherein a guiding structure is protruded out of a periphery of the triggering path for guiding the user's finger.

5. A controller for a massage device, comprising: a body fixed on the massage device, at least one triggering path, a plurality of sensors and at least one control member, characterized in that:
the triggering path is disposed on the body and is provided with a plurality of adjacent and orderly connected contact areas;
the sensors are disposed on the body and are located correspondingly to the contact areas of the triggering path, when foreign objects touch the contact areas of the triggering path, the contact areas will make the sensors produce signals;
the control member is electrically connected to the sensors, when the single sensor produces signals, the control member will receive the signals and produce a predetermined function control, when a user continuously triggers at least more than two of the adjacent contact areas along a predetermined direction of the triggering path, the control member will make the massage device produce another predetermined function control;
a sound effect assembly is electrically connected to the control member so as to produce a sound effect.

6. The controller for a massage device as claimed in claim 5, wherein the sensors are selected from the group consisting of an ordinary capacitive sensor, a proximity sensor and a pressure sensor.

7. The controller for a massage device as claimed in claim 5, wherein the contact areas of the triggering path form a path surface for the user's finger to trigger, and the path surface is selected from the group consisting of a flat path surface, a bended path surface, a concave arc-shaped path surface and a convex arc-shaped path surface.

8. The controller for a massage device as claimed in claim 7, wherein a guiding structure is protruded out of a periphery of the triggering path for guiding the user's finger.

9. A controller for a massage device, comprising: a body fixed on the massage device, at least one triggering path, a plurality of sensors and at least one control member, characterized in that:
the triggering path is disposed on the body and is provided with a plurality of adjacent and orderly connected contact areas;
the sensors are disposed on the body and are located correspondingly to the contact areas of the triggering path;
the control member is electrically connected to the sensors, when a user continuously triggers at least more than two of the adjacent contact areas along a predetermined direction of the triggering path, the control member will produce a predetermined function control or position control of the massage device.

10. The controller for a massage device as claimed in claim 9, wherein the function control of the massage device controls more than one of the functionally quantitative adjustments of massage intensity, massage speed and massage time.

11. The controller for a massage device as claimed in claim 9, wherein the position control of the massage device is a relative position or angle of the quantity adjusted massage device and a massaged person.
